(19) United States
(12) Patent Application Publication
(10) Pub. No.: US 2007/0001967 A1
(43) Pub. Date: Jan. 4, 2007

(54) Liquid crystal display panel module and scan driver thereof

(75) Inventors: Chi-Mao Hung, Chiayi City (TW); Wan-Chi Hsu, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/256,407

(22) Filed: Oct. 21, 2005

(30) Foreign Application Priority Data
Jul. 1, 2005 (TW) 94122405

(51) Int. Cl. G09G 3/36

(52) U.S. Cl. 345/98

(57) ABSTRACT

A liquid crystal display (LCD) panel module and scan driver thereof is disclosed. The LCD panel module includes a LCD panel having data electrodes and scan electrodes, a scan driver and a data driver. The scan driver includes a timing controller, a scale-adjusting function circuit and an image gamma modulation circuit. The timing controller generates a first control signal and second control signal according to a first clock signal. The scan driver is controlled by the first control signal to drive the scan electrodes. The scale-adjusting function circuit adjusts an image scale corresponding to a first display signal and outputting a second display signal accordingly. The image gamma modulation circuit performs a gamma modulation on the second display signal to output a third display signal. The data driver, disposed on the LCD panel, drives the data electrodes to display pictures on the LCD panel according to the second control signal.

This application claims the benefit of Taiwan application Serial No. 94122405, filed Jul. 1, 2005, the subject matter of which is incorporated herein by reference.

### BACKGROUND OF THE INVENTION

1. Field of the Invention

The invention relates in general to a display module and driver thereof, and more particularly to a liquid crystal display (LCD) panel module and scan driver thereof.

2. Description of the Related Art

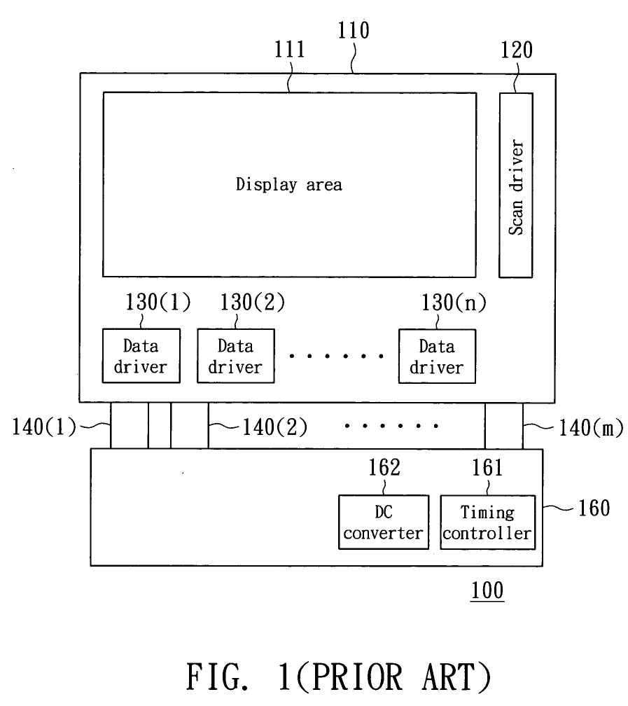

Referring to FIG. 1, a schematic diagram of a conventional LCD panel module is shown. The LCD panel module 100 includes a LCD panel 110, a scan driver 120, and data drivers 130(1)˜130(n). The LCD panel 110 includes a display area 111 having a number of display units, scan electrodes, and data electrodes. The scan driver 120 controls the scan electrodes of the LCD panel 110 to turn on thin film transistors in the display units of the LCD panel 110 row by row while the data drivers 130(1)˜130(n) drive the corresponding display units through the data electrodes to display pictures on the display area 111. A number of display-related devices are disposed on a circuit board 160, such as a timing controller for controlling the scan driver 120 and the data drivers 130(1)˜130(n), a DC converter 162 for supplying voltages to the LCD panel module 100.

For the timing controller 161 has to output control signals to the data drivers 130(1)˜130(n), and the DC converter 162 has to output voltages to the LCD panel module 100, flexible printed circuits (FPCs) 140(1)˜140(m) are disposed between the circuit board 160 and the LCD panel module 100 for transmitting signals. Through the flexible printed circuits 140(1)˜140(m), devices on the circuit board 160 can communicate with the LCD panel module 100.

However, a great number of transmission lines are required for each data driver 130(1)˜130(n) requires a control signal. Therefore, a great deal of flexible printed circuits are needed to transmit the control signals for the data drivers 130(1)˜130(n). The larger the scale of LCD panel is, the larger the number of the required data drivers and thus the flexible printed circuits is. Consequently, the larger area of the LCD panel module 100 is required for signal wiring layout in addition to the LCD panel. If signals transmitted between other circuits 160 and the LCD panel module 100, such as video signals required for the data drivers 130(1)˜130(n), voltage signals for operation of the LCD panel module 100, and control signals for the scan driver 120, are taken into consideration, the more flexible printed circuits are needed for transmitting the signals to the LCD panel module 100, thereby increasing production cost and circuit complexity.

### SUMMARY OF THE INVENTION

It is therefore an object of the invention to provide a LCD panel module and scan driver thereof. According to the invention, the amount of flexible printed circuits can be lowered down to reduce the circuit complexity and production cost.

The invention achieves the above-identified object by providing a scan driver, for use in a LCD panel. The scan driver includes a timing controller, a scale-adjusting function circuit and an image gamma modulation circuit. The timing controller generates a first control signal and a second control signal according to a first clock signal, and drives the scan electrodes according to the first control signal. The scale-adjusting function circuit adjusts an image scale corresponding to a first display signal and outputs a second display signal accordingly. The image gamma modulation circuit performs a gamma modulation on the second display signal to output a third display signal.

Moreover, the second control signal is applied to a data driver, and the data driver, in response to the second control signal, is adapted to drive the LCD panel to display pictures in accordance with the third display signal.

The invention achieves the above-identified object by providing a LCD panel module including a LCD panel, a scan driver and a data driver. The LCD panel includes a number of data electrodes and scan electrodes. The scan driver is electrically coupled to the scan electrodes and disposed on the LCD panel. The scan driver includes a timing controller, a scale-adjusting function circuit and an image gamma modulation circuit. The timing controller generates a first control signal and a second control signal according to a first clock signal, and drives the scan electrodes according to the first control signal. The scale-adjusting function circuit adjusts an image scale corresponding to a first display signal and outputs a second display signal accordingly. The image gamma modulation circuit performs a gamma modulation on the second display signal to output a third display signal. The data driver is electrically coupled to the data electrodes and disposed on the LCD panel. The data driver, in response to the second control signal, is adapted to drive the LCD panel to display pictures in accordance with the third display signal.

Other objects, features, and advantages of the invention will become apparent from the following detailed description of the preferred but non-limiting embodiments. The following description is made with reference to the accompanying drawings.

### BRIEF DESCRIPTION OF THE DROWINGS

FIG. 1 is a schematic diagram of a conventional LCD panel module.

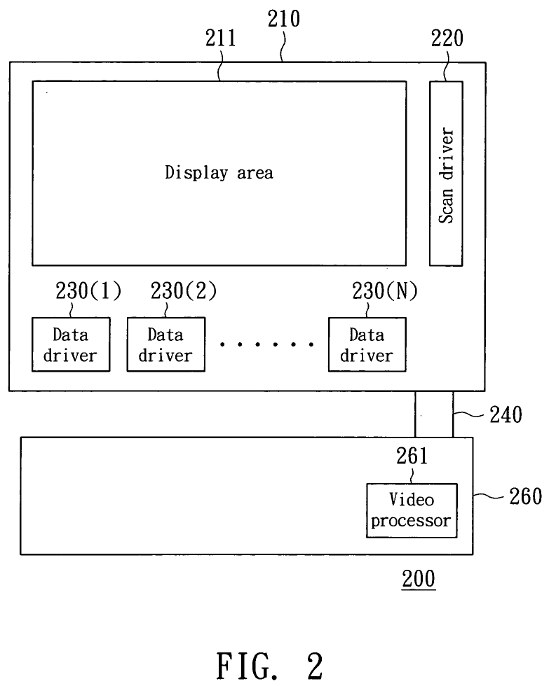

FIG. 2 is a schematic diagram of a LCD panel module according to a preferred embodiment of the invention.

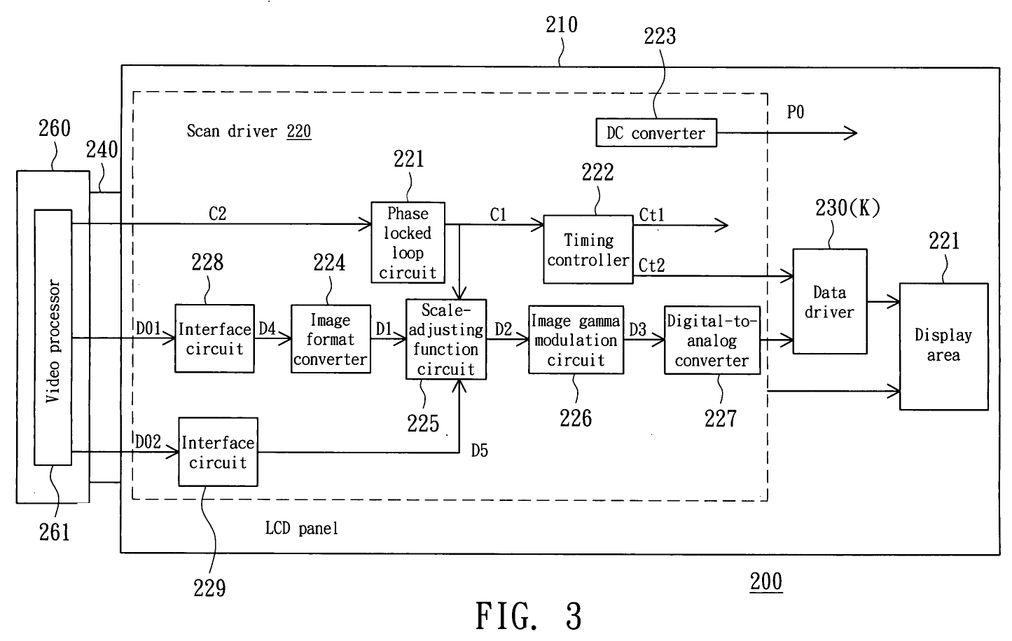

FIG. 3 is a block diagram of a LCD panel module according to a preferred embodiment of the invention.

### DETAILED DESCRIPTION OF THE INVENTION

Referring to FIG. 2, a schematic diagram of a LCD panel module according to a preferred embodiment of the invention is shown. The LCD panel module 200 includes a LCD panel 210, a scan driver 220, a data driver 230(1)˜230(N), and a printed circuit board 260. The LCD panel 210 includes a display area 211 having a number of display units, data electrodes and scan electrodes (not shown in the figure). The scan driver 220 controls the scan electrodes to turn on thin film transistors of the display units row by row while the data drivers 230(1)˜230(N) drive the corresponding data electrodes to display pictures on the LCD panel 210. The LCD panel 210 is electrically coupled to devices on the circuit board 260 through the flexible printed circuits 240.

A video processor 261, disposed on the circuit board 260, transmits signals to the scan driver 220 to drive the data drivers 230(1)˜230(N). The video processor 261 outputs an original display signal D01 and a clock signal C2, or an original display signal D02 and a clock signal C2 to the scan driver 220 through the flexible printed circuits after performing an image processing.

Referring to FIG. 3, a block diagram of a LCD panel module according to a preferred embodiment of the invention is shown. The data driver 230(k) denotes any one of the data drivers 230(1)˜230(N), and the relationship between the scan driver 220 and the corresponding data driver 230. The scan driver is electrically coupled to the scan electrodes of the LCD panel 210 and disposed on the LCD panel 210. The scan driver 220 is electrically coupled to the video processor 261 through the flexible printed circuits 240. The scan driver 220 includes a phase locked loop circuit 221, a timing controller 222, a DC converter 223, an image format converter 224, a scale-adjusting function circuit 225, an image gamma modulation circuit 226, a digital-to-analog converter 227, and interface circuits 228 and 229.

The DC converter 223 is for converting a main voltage to generate an operational voltage P0 for the LCD panel 210. The phase locked loop circuit 221 applies the clock signal C1 to the timing controller 222 and scale-adjusting function circuit 225 responsive to the clock signal C2. The phase locked loop circuit 221 generates clock signals of various frequencies in accordance with the revolution of the display area. The timing controller 222 generates control signals Ct1 and Ct2 according to the clock signal C1. The scan driver 220 drives the scan electrodes of the LCD panel 210 according to the control signal Ct1 while the data driver 230(k) drives the data electrodes of the LCD panel 210 according to the control signal Ct2.

When the video processor 261 outputs the original display signal DO1 and the clock signal C2, the scan driver 220 receives the original display signals DO1 by using different interface devices according to their formats, and processes the original display signals DO1 according to corresponding signal paths. For example, when the original display signals DO1 are YUV signals, CCIR-601 signals or CCIR-656 signals, the interface circuit 228 is used to receive the original display signals DO1 and to generate and output display signals D4 to the image format converter 224 accordingly. The image format converter 224 converts a format of the display signals D4 to generate display signals D1. The image format converter 224 is, for example, an YCbCr-to-RGB format converter wherein the display signals D4 have the YCbCr format and the display signals D1 have the RGB format.

When the video processor 261 outputs the original display signals DO2, such as serial RGB signals or parallel RGB signals, and the clock signal C2, the interface circuit 229 is used to receive the original display signals DO2 and to generate and output display signals D5 to the scale-adjusting function circuit 225 according to the original display signals DO2. When the original display signals DO2 are parallel RGB signals, the interface circuit 229 converts the parallel display signals to serial display signals D5. As mentioned above, the scan driver 220 can process a lot of display signals output by the video processor 261 for displaying pictures on the LCD panel 210. The supported display signals include YUV signals, CCIR-601 signals or CCIR-656 signals, serial RGB signals, such as RGB serial D[7:0], or parallel RGB signals, such as RGB parallel D[23:0].

The scale-adjusting function circuit 225, in response to the clock signal C1, adjusts the image scale corresponding to the display signals D1 or D5 and outputs display signals D2 accordingly. The image gamma modulation circuit 226 performs gamma modulation on the display signals D2 and outputs display signals D3 accordingly.

The data driver 230(k) drives the data electrodes of the display area 211 according to the control signal Ct2 and the display signals D3 for displaying pictures on the LCD panel 210.

In addition, the digital-to-analog converter 227, electrically coupled to the image gamma modulation circuit 116 and the data driver 230, can be disposed in the scan driver 220 or the data drivers 230(1)˜230(N). The digital-to-analog converter 227 is for converting the display signals D3 to analog signals and outputting the analog signals to the data driver 230.

The data drivers 230(1)˜230(N) are, for example, cascaded and disposed on the LCD panel 210.

The scan driver 220 further includes a charge pump, a programmable LED controller, a contrast/brightness/hue/saturation adjuster, and a VCOM_DC &AC adjuster. The scan driver 220 can perform complex video processing directly and thus greatly reduce the number of signal wiring and flexible printed circuits between the LCD display panel 210 and the circuit board 260.

The LCD panel module and scan driver thereof according to the above-mentioned embodiment of the invention has advantages as follows. By using a novel structure of the LCD panel module, signal transmission loading between the LCD panel and the circuit board is reduced and thus the number of flexible printed circuits and the required layout area can be greatly reduced. Therefore, the LCD's circuit can be simplified, production cost be reduced and competitive power be increased. The scan driver can support display signals of various formats, thereby increasing its application scope and compatibility.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scan driver for use in a liquid crystal display (LCD) panel, the LCD panel comprising a plurality of scan electrodes electrically coupled to the scan driver, comprising:
a timing controller for generating a first control signal and a second control signal according to a first clock signal, and for driving the scan electrodes according to the first control signal;
a scale-adjusting function circuit for adjusting an image scale corresponding to a first display signal, and for outputting a second display signal accordingly; and
an image gamma modulation circuit for performing a gamma modulation on the second display signal to output a third display signal;
wherein the second control signal is applied to a data driver, and the data driver, in response to the second control signal, is adapted to drive the LCD panel to display pictures in accordance with the third display signal.

2. The scan driver according to claim 1, further comprising a DC converter for converting a main voltage to an operational voltage for the LCD panel.

3. The scan driver according to claim 1, further comprising a phase locked loop circuit for applying the first clock signal to the timing controller and the scale-adjusting function circuit responsive to a second lock signal, wherein the scale-adjusting function circuit, in response to the first clock signal, is adapted to output the second display signal in accordance with the first display signal.

4. The scan driver according to claim 3, further comprising:
an interface circuit for receiving an original display signal and generating a forth display signal according to the original display signal; and
an image format converter for converting a format of the forth display signal to generate the first display signal, and for applying the first display signal to the scale-adjusting function circuit.

5. The scan driver according to claim 4, wherein the forth display signal is of YCbCr format, the first display signal is of RGB format, the original display signal is a YUV signal, a CCIR-601 signal or a CCIR-656 signal.

6. The scan driver according to claim 3, further comprising an interface circuit for receiving an original display signal and generating the first display signal, and for applying the first display signal to the scale-adjusting function circuit according to the original display signal.

7. The scan driver according to claim 6, wherein the original display signal is a serial RGB signal.

8. The scan driver according to claim 6, wherein the original display signal is a parallel RGB signal and the first display signal is transmitted in serial.

9. The scan driver according to claim 1, further comprising a digital-to-analog converter, electrically coupled to the image gamma modulation circuit and the data driver, for converting the third display signal to an analog signal and applying the analog signal to the data driver.

10. A liquid crystal display (LCD) panel module incorporating the scan driver of claim 1.

11. The LCD panel module according to claim 10, further comprising:
a printed circuit board; and
a video processor, disposed on the printed circuit board, for outputting an original display signal and a second clock signal after performing an image processing, wherein the scan driver is adapted to generate the first clock signal according to the second clock signal;
wherein the scan driver further comprises:
an interface circuit for receiving the original display signal and generating a forth display signal according to the original display signal; and
an image format converter for converting a format of the forth display signal to generate the first display signal, and for applying the first display signal to the scale-adjusting function circuit.

12. The LCD panel module according to claim 11, further comprising a flexible printed circuit, wherein the flexible printed circuit is adapted for connecting the printed circuit board and the LCD panel, and the video processor is adapted to transmit the original display signal and the second clock signal to the scan driver through the flexible printed circuit.

13. The LCD panel module according to claim 10, further comprising:
a printed circuit board; and
a video processor disposed on the printed circuit board, wherein the video processor is adapted to output an original display signal and the second clock signal after performing an image processing, and the scan driver is adapted to generate the first clock signal according to the second clock signal;
wherein the scan driver further comprises an interface circuit for receiving an original display signal and generating the first display signal, and for outputting the first display signal to the scale-adjusting function circuit according to the original display signal.

14. The LCD panel module according to claim 13, further comprising a flexible printed circuit for connecting the printed circuit board and the LCD panel, wherein the video processor is disposed on the printed circuit board and adapted to transmit the original display signal and the second clock signal to the scan driver through the flexible printed circuit.
